(19) United States
(12) Patent Application Publication
(10) Pub. No.: US 2006/0064875 A1
(43) Pub. Date: Mar. 30, 2006

(54) Shaving implement employing discrete cartridge sections

(75) Inventors: Thomas A. Follo, Milford, CT (US); Paul D. Richard, Shelton, CT (US)

Correspondence Address: MICHAUD-DUFFY GROUP LLP, 306 INDUSTRIAL PARK ROAD, SUITE 206, MIDDLETOWN, CT, 06457, US

(73) Assignee: Eveready Battery Company, Inc., St. Louis, MO (US)

(21) Appl. No.: 11/227,951

(22) Filed: Sep. 14, 2005

Related U.S. Application Data
(60) Provisional application No. 60/612,656, filed on Sep. 24, 2004.

(51) Int. Cl. B26B 19/10; B26B 19/38

(52) U.S. Cl. 30/34.1

(57) ABSTRACT

In a razor cartridge a frame is provided and carries at least two discrete cartridge segments each positioned in the frame for individual movement relative thereto. Each of the cartridge segments includes at least one razor blade that defines an at least partially exposed cutting edge.

### CROSS REFERENCE TO RELATED APPLICATIONS

This patent application is related to and claims priority under 35 U.S.C. §119(e) of U.S. Provisional patent application Ser. No. 60/612,656, entitled “Shaving Implement Employing Discrete Cartridge Sections,” filed on Sep. 24, 2004. The disclosure of this patent application is incorporated by reference herein in its entirety.

### FIELD OF THE INVENTION

The present invention relates generally to wet shave razors and, more particularly, to a razor cartridge incorporating discrete independently moveable cartridge segments.

### BACKGROUND OF THE INVENTION

Wet shave razors have historically incorporated razor cartridges that employ one or more elongated razor blades located therein. Often these razor cartridges pivot relative to a handle to which they are coupled to allow cutting edges defined by the razor blades to more closely follow the contours of a surface to be shaved. However, due to the elongated nature of the cutting edges, as well as the often complex contours of the surface being shaved, the pivoting of the razor cartridge is sometimes not adequate to provide for conformity of the razor blades to the skin surface.

Based on the foregoing, it is the general object of the present invention to provide a razor cartridge and/or wet shave razor that improves upon or overcomes the inability of prior art razors to precisely follow the contours of a surface to be shaved during a shaving operation.

### SUMMARY OF THE INVENTION

The present invention resides in one aspect in a razor cartridge having a frame and at least two discrete cartridge segments positioned therein and moveable relative thereto. Each of the cartridge segments includes at least one razor blade having an at least partially exposed cutting edge. Preferably, the razor cartridge includes a plurality of discrete cartridge segments each positioned in, and independently movable relative to the frame.

Biasing means are positioned in the frame and are in communication with each of the cartridge segments for normally urging the cartridge segments and razor assemblies disposed therein in a direction towards the surface to be shaved (a neutral position) in response to forces exerted against the cartridge segments during a shaving operation. In one embodiment of the present invention, the biasing means take the form of cantilevered spring members, each having one end resiliently coupled to the frame and a generally opposite cantilevered end engageable with an underside of one of the cartridge segments. The cantilevered spring members normally urge the cartridge segments with which they are engaged, toward the neutral position. While a cantilevered spring has been described, the present invention is not limited in this regard as other forms of biasing means known to those skilled in the pertinent art to which the present invention pertains, such as, for example, coil springs, leaf-type springs, and resilient materials such as, for example, foam, which can be substituted without departing from the broader aspects of the present invention.

In one embodiment, each of the cartridge segments includes a housing and two razor blade assemblies positioned in the housing. Each razor blade assembly includes a razor blade having an at least partially exposed cutting edge. The cartridge segments can be positioned in the frame in rows that are substantially parallel to one another, with the same or different numbers of cartridge segments in each row. In one embodiment, the cartridge segments can be positioned in the frame in arcuate, circular, or other nesting patterns. While the cartridge segments have been illustrated as including two razor blade assemblies per segment, the present invention is not limited in this regard as less than or more than two razor blade assemblies can be employed in each cartridge segment.

In another embodiment of the present invention, the cartridge segments can be positioned in the frame so that the cutting edges of the razor blades positioned in the razor blade assemblies in some of the cartridge segments generally face away from the cutting edges of the razor blades of the remaining cartridge segments. With the cartridge segments configured in this manner, the razor cartridge can cut hair when moved over a surface to be shaved in either of two generally opposite directions.

Similarly, one portion of the cartridge segments can be positioned in the frame so that the cutting edges of some of the blades located therein generally face toward the cutting edges of the blades positioned in the remainder of the cartridge segments. This configuration also allows the razor cartridge to cut hair when moved over a surface to be shaved in either of two generally opposite directions.

In one embodiment, the present invention includes a wet shave razor incorporating the above-described razor cartridge either permanently or releasably mounted onto a razor handle.

### BRIEF DESCRIPTION OF THE DRAWINGS

FIG. 1 is a top view of a razor cartridge configured in accordance with the present invention.

FIG. 2 is a front view of the razor cartridge of FIG. 1.

FIG. 3 is a side view of the razor cartridge of FIG. 1.

FIG. 4 is a perspective view of a cartridge segment configured in accordance with the present invention.

FIG. 5 is a cross-sectional view of a razor blade assembly forming part of a cartridge segment.

FIG. 6 is a front view of the razor blade assembly of FIG. 5.

FIG. 7 is a bottom view of the razor blade assembly of FIG. 5.

FIG. 8 is a perspective view of a frame forming part of the razor cartridge of FIG. 1, showing a plurality of cantilevered springs and resilient retaining members.

FIG. 9 is a cross-sectional view of the razor cartridge of FIG. 1 taken along line 9-9 through the center of the razor cartridge. The cartridge segments beings positioned in two successive rows with the cartridge segments being staggered so that line 9-9 bisects one cartridge segment in one row and is positioned between adjacent cartridge segments in the other row.

FIG. 10 is a cross-sectional view of the razor cartridge of FIG. 1 taken along line 10-10 and shows the manner by which the cartridge segments engage the frame.

FIG. 11 is a cross-sectional view of the razor cartridge of FIG. 1 taken along line 11-11 which extends through one of the cartridge segments and through an end portion of the frame.

FIGS. 12, 12a, and 12b are top views of embodiments of the razor cartridge of the present invention showing cartridge segments positioned in an arcuate pattern.

FIG. 13 is a cross-sectional view of a pair of razor cartridge segments positioned relative to one another so that the razor blades carried by one cartridge segment face away from the razor blades carried by the other cartridge segment thereby illustrating how these cartridge segments would be positioned relative to one another in a razor cartridge to facilitate bi-directional shaving.

FIG. 14 is a cross-sectional view of a pair of cartridge segments positioned relative to one another so that the razor blades carried by one cartridge segment face toward the razor blades carried by the other cartridge segment thereby illustrating how these cartridge segments would be positioned relative to one another in a razor cartridge to facilitate bidirectional shaving.

FIG. 15 is a top view of a wet shave razor incorporating the razor cartridge as illustrated in FIG. 1.

FIG. 16 is a rear view of a wet shave razor incorporating the razor cartridge as illustrated in FIG. 1.

FIG. 17 is a side view of a wet shave razor incorporating the razor cartridge as illustrated in FIG. 1.

FIG. 18 shows a razor cartridge segment having wire wrapped cartridge segments.

FIG. 19 is a top view of an embodiment of a razor cartridge of the present invention showing a plurality of cartridge segments positioned adjacent a single longitudinally extending razor blade.

### DETAILED DESCRIPTION OF THE PREFERRED EMBODIMENTS

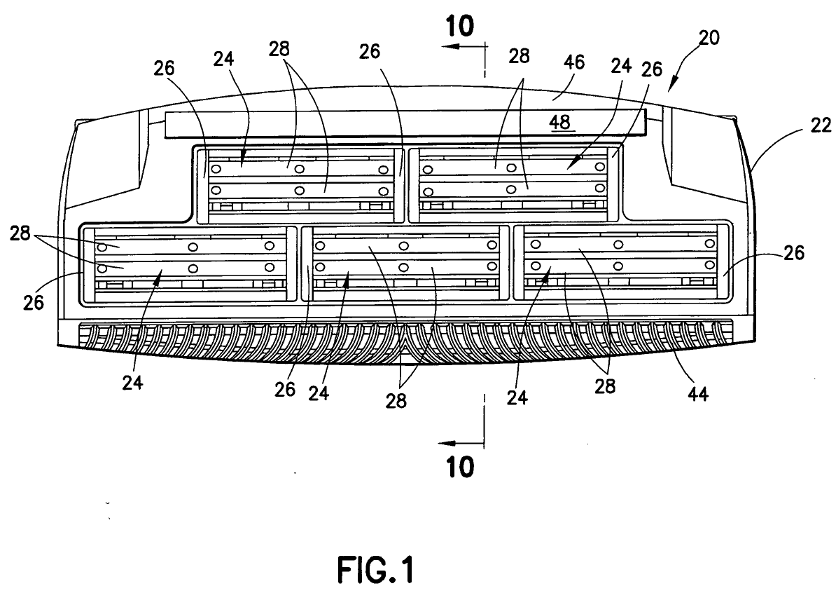

As shown in FIG. 1, a razor cartridge generally designated by the reference number 20, includes a frame 22 and a plurality of discrete cartridge segments, generally designated by the reference number 24, coupled thereto. As will be explained in detail below, the cartridge segments 24 are coupled to the frame 22 and are each independently moveable relative thereto. In one embodiment, illustrated in FIG. 4, each cartridge segment 24 includes a housing 26 with two razor blade assemblies 28 positioned therein. Each of the razor blade assemblies 28 includes a razor blade 31 having an exposed cutting edge 33. In accordance with one aspect of the invention, a length of the exposed cutting edge 33 of each of the razor blades 31 is a relatively shorter dimension than a length of exposed cutting edges of conventional blades assemblies. For example, exposed cutting edges of conventional razor blades extend over substantially all of the elongated length of a conventional cartridge frame. The Inventors have discovered that a wet shave razor employing a razor cartridge including a combination of shorter length cutting edges and discrete, independently moveable cartridge segments allows the razor cartridge to more closely follow contours of a surface to be shaved.

As shown in FIG. 4, the cartridge segments 24 include a pair of end caps 29 one attached to each end of the housing 26. Each end cap 29 is positioned over a portion of each of the razor blade assemblies 28 to aid in retaining the razor blade assemblies in the housing 26. While the cartridge segments 24 have been shown and described as including two razor blade assemblies 28, the present invention is not limited in this regard as more or less than two razor blade assemblies can be positioned in the housing 26 without departing from the broader aspects of the present invention.

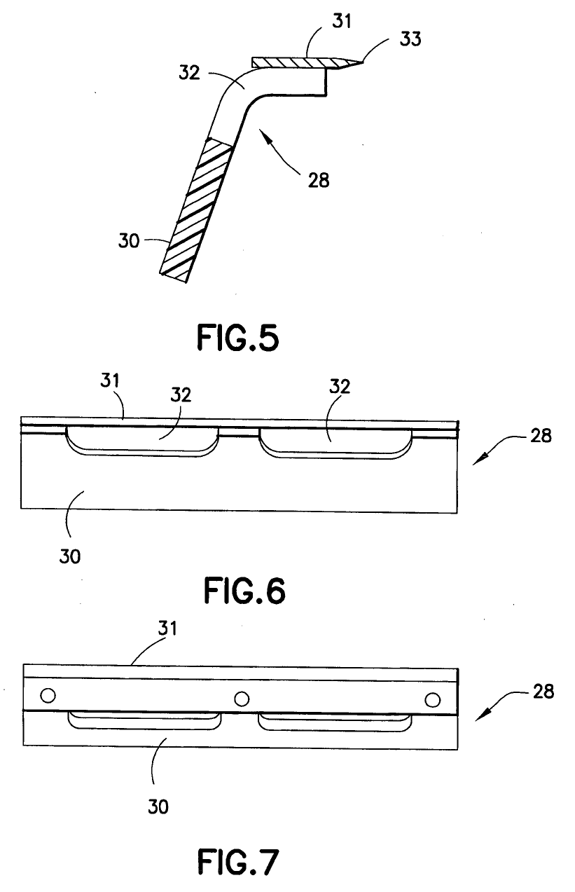

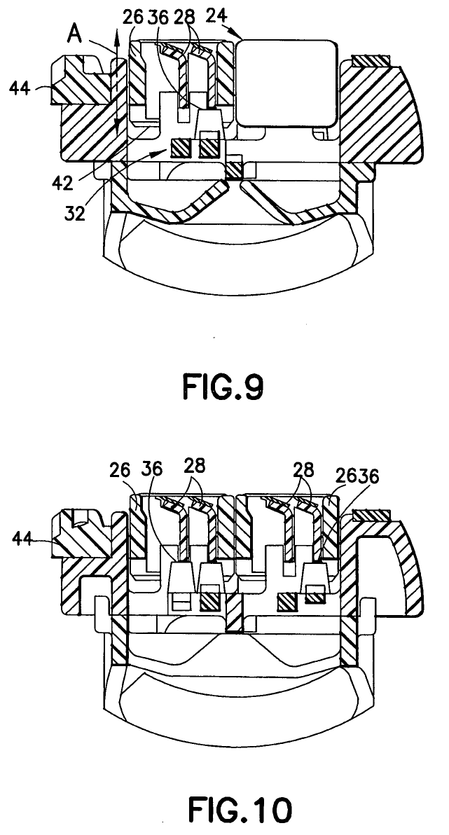

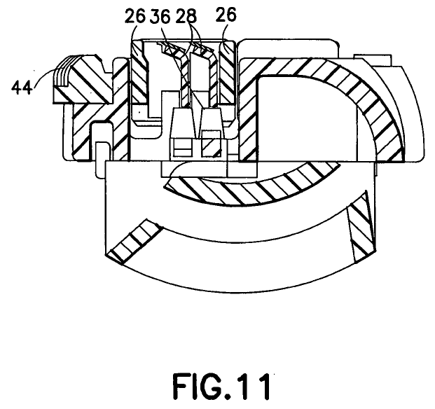

As shown in FIGS. 5-7, each razor blade assembly 28 includes a stiffener 30 and a razor blade 31 attached to the stiffener 30. Each stiffener 30 defines a pair of apertures 32 located adjacent to the razor blade 31 to allow for a wash through of shaving debris during a shaving operation. Referring to FIGS. 9-11, the razor blade assemblies 28 are positioned in the cartridge segments 24, with the stiffeners 30 located so as to desirably orient the razor blades 31 relative to the frame 22 as well as to a surface to be shaved during a shaving operation.

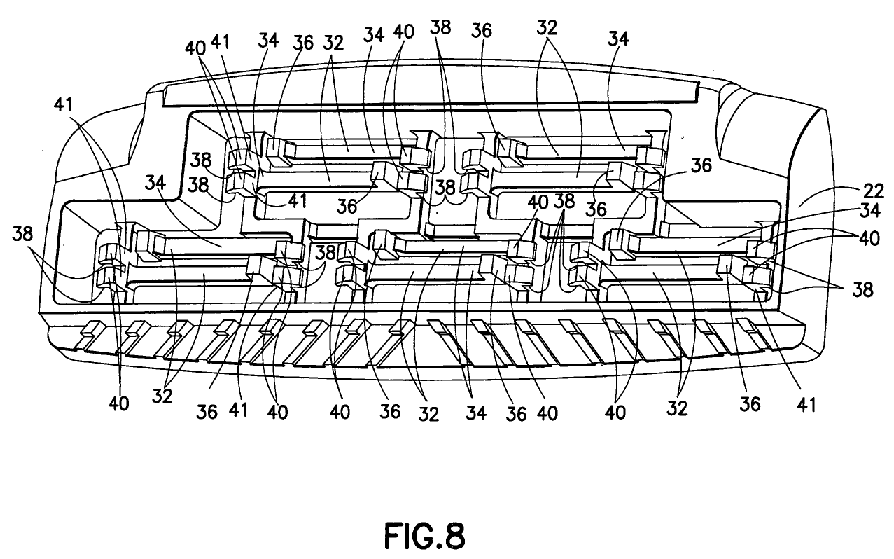

As shown in FIG. 8, the frame 22 includes a plurality of cantilevered spring members 32, each cantilevered spring member 32 having one end 34 resiliently integral with the frame 22 and a generally opposite cantilevered end 36. As will be explained in detail below, each cantilevered end 36 is engageable with an underside, shown generally at 35, of one of the cartridge segments 24 and moveably supports the one respective cartridge segment 24. Referring to FIGS. 9-11 during a shaving operation a pair of the cantilevered spring members 32 is positioned adjacent the underside 35 of each cartridge segment 24 with the cantilevered ends 36 of each spring member 32 abutting an end of the underside 35 of the cartridge segment 24.

During a shaving operation, each cartridge segment 24 is independently moveable relative to the frame 22 and is normally urged, by the cantilevered spring members 32, in an upward direction (indicated by arrow “A” of FIG. 9) towards a surface to be shaved into an upper-most or neutral position. While the frame 22 and spring members 32 have been shown and described as being integral with one another, the present invention is not limited in this regard as the spring members and the frame can also be distinct from one another without departing from the broader aspects of the present invention.

Referring back to FIG. 8, the frame 22 includes resilient retaining members 40 each of which define stand-off portions 41 that extend outwardly from the frame 22. The cartridge segments 24 are each movably retained on the frame 22 by abutment surfaces 38 at an underside of the resilient retaining members 40. During assembly of the razor cartridge 20, each cartridge segment 24 is slid over four retaining members 40, one proximate each corner of the cartridge segment 24. As the cartridge segments 24 are slid over the resilient retaining members 40, the stand off portions 41 of the resilient retaining members 40 deform allowing a portion of the cartridge segment 24 to slide past the abutment surfaces 38 and engage a pair of the cantilevered spring elements 32. Once a lip portion 42 defined by the housing 26 clears the abutment surfaces 38 the retaining members 40 move into an undeformed state so that the cartridge segment 24 can move (e.g., vertical translation) relative to the retaining member 40 until the lip portion 42 of the housing 26 engages the abutment surface 38 of the retaining member 40. The position of the cartridge segments 24 when the lip portion 42 is engaged with the abutment surfaces 38 is defined herein as the aforementioned upper-most or neutral position of the cartridge segment 24.

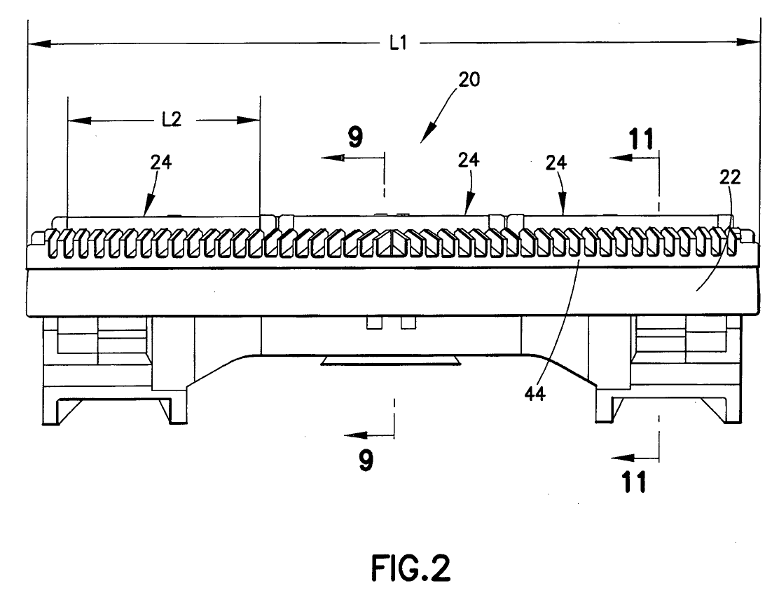

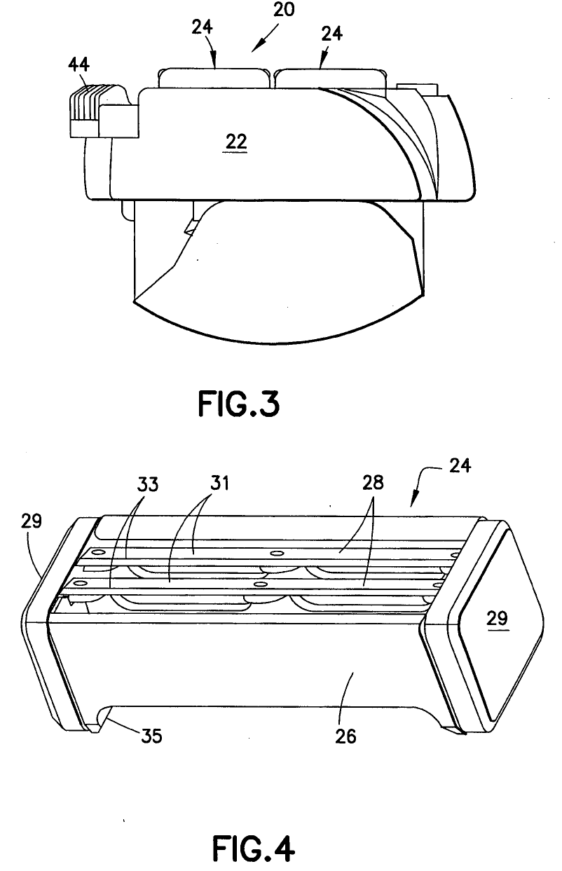

As shown in FIGS. 1-3, and 9-11, the razor cartridge 20 includes a guard bar 44 coupled to the frame 22 adjacent a leading edge thereof, for stretching a surface to be shaved (e.g., a user's skin), during a shaving operation, prior to the surface contacting the cutting edges 33 of the razor blades 31. In one embodiment, the guard bar 44 is made of the same or a different material as the frame 22. In another embodiment, the guard bar 44 employs a smooth or an uneven skin contacting surface. In yet another embodiment, the guard bar 44 incorporates a shaving aid, such as, but not limited to, an oil, a gel, medicaments, or lotion. In still another embodiment, the guard bar 44 is formed from a reduced friction material. A guard bar configured as illustrated above, is generally referred to by those skilled in the pertinent art to which the present invention pertains as a “glide strip.”

Still referring to FIGS. 1-3, and 9-11, the frame 22 includes a cap portion 46 having a comfort strip 48 coupled thereto. While the present invention has been shown and described as including a single comfort strip, the present invention is not limited in this regard as more than one comfort strip can be incorporated into the razor cartridge without departing from the broader aspects of the present invention. In one embodiment, a comfort strip is located in close proximity to each of the cartridge segments 24, for example, on a surface of the frame 22 behind the cutting edges 33 of each razor blade 31.

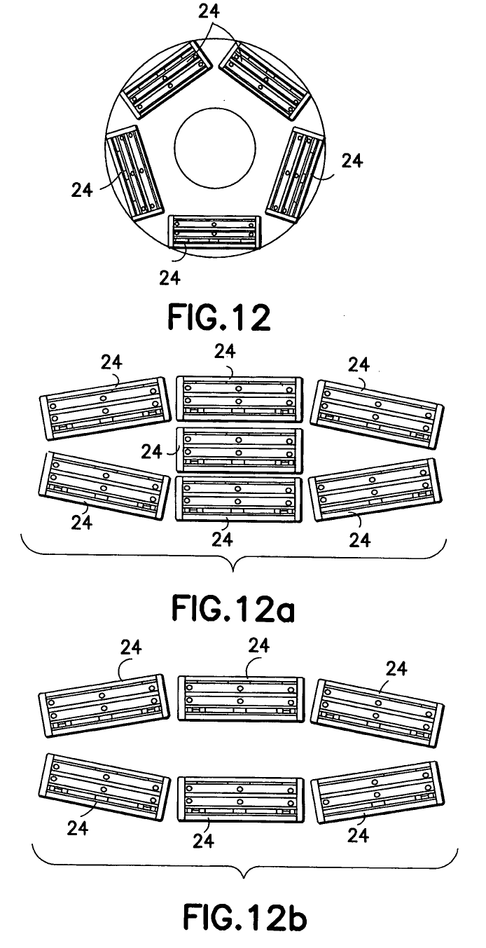

Referring back to FIG. 1 the illustrated embodiment of the razor cartridge 20 includes five cartridge segments 24 positioned in the frame 22 in two substantially parallel rows, one row containing two cartridge segments and another row containing three cartridge segments. However, it should be appreciated that the present invention is not limited in this regard as any number of rows, each containing the same or different numbers of cartridge segments 24 can be employed. Moreover, while the cartridge segments 24 have been shown and described as being positioned in the frame 22 in substantially parallel rows, the present invention is not limited in this regard as other configurations such as arcuate or circular rows can also be used. For example, as shown in FIGS. 12, 12a, and 12b the cartridge segments 24 are positioned in circular and arcuate patterns in the frame 22. With respect to FIG. 12, the cartridge segments 24 are illustrated so that the cutting edges 33 of the razor blades 31 generally face inwardly toward one another. In another embodiment, the cartridge segments 24 are positioned so that the cutting edges 33 of the razor blades 31 face outwardly. Moreover, while FIGS. 12a and 12b show specific arcuate cartridge segment nesting patterns, it should be appreciated that the present invention is not limited in this regard as any number of different arcuate nesting patterns can be employed without departing from the present invention.

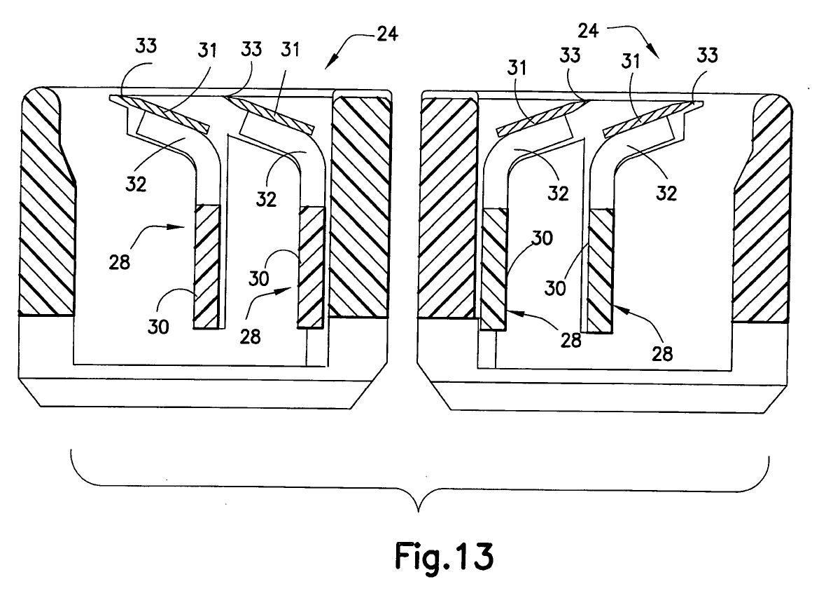

As shown in FIG. 13, the cartridge segments 24 can be arranged relative to one another in successive rows so that the cutting edges 33 of the razor blades 31 of the cartridge segments 24 positioned in one row face away from the cutting edges 33 of the razor blades 31 in an adjacent row thus allowing the razor cartridge 20 to cut hair when drawn over a user's skin in either of two generally opposite directions. While the illustrated embodiment shows the cutting edges 33 of the razor blades 31 carried by cartridge segments 24 in adjacent rows facing away from another to facilitate bi-directional shaving, the present invention is not limited in this regard.

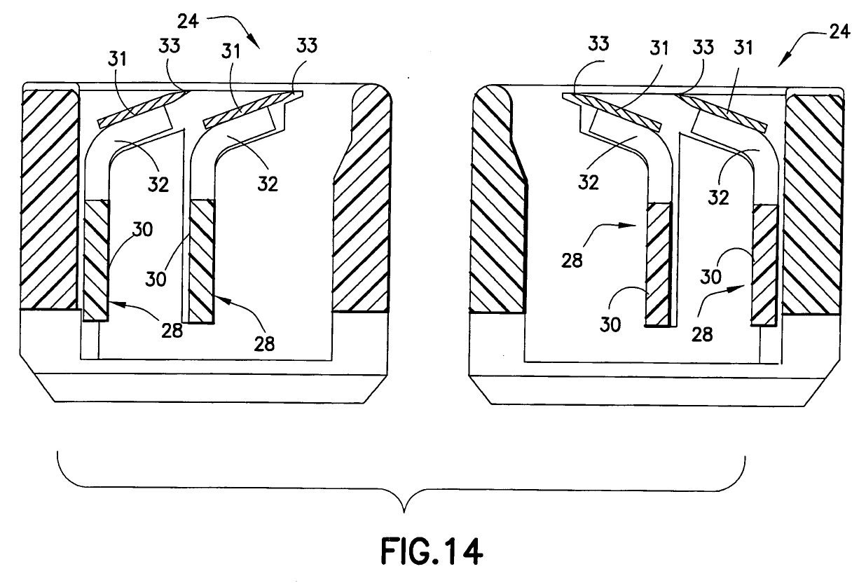

As shown in FIG. 14, the cartridge segments 24 can be positioned in successive rows such that the cutting edges 33 of the razor blades 31 positioned in the cartridge segments in one row generally face towards the cutting edges 33 of the razor blades 31 positioned in the cartridge segments 24 in the adjacent row. This embodiment also facilitates bi-directional shaving. While the cartridge segments 24 shown in FIGS. 13 and 14 illustrate the positioning of the cartridge segments for bi-directional shaving in a razor cartridge 20 having only two rows of cartridge segments, it should be appreciated that the present invention is not limited in this regard as any number of rows of cartridge segments can be employed in a razor cartridge without departing from the broader aspects of the present invention.

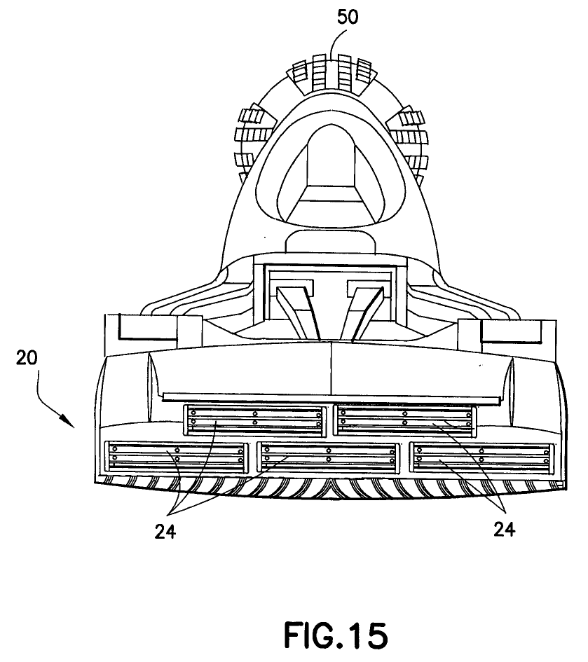

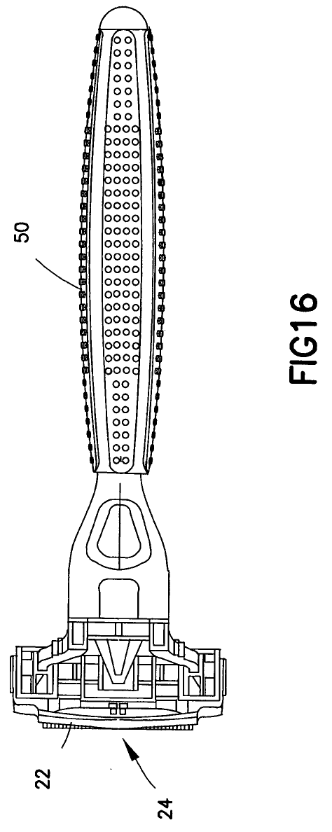

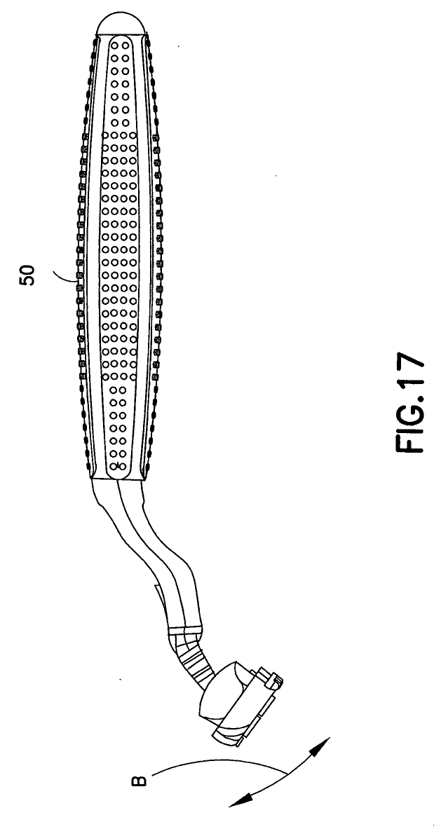

As shown in FIGS. 15-17, the above described razor cartridge 20 can be attached, either permanently or releasably to a handle 50. The razor cartridge 20 can pivot relative to the handle 50 as indicated by the arrows labeled “B.” However, the present invention is not limited in this regard as razor cartridge can also be non-rotatable relative to the handle.

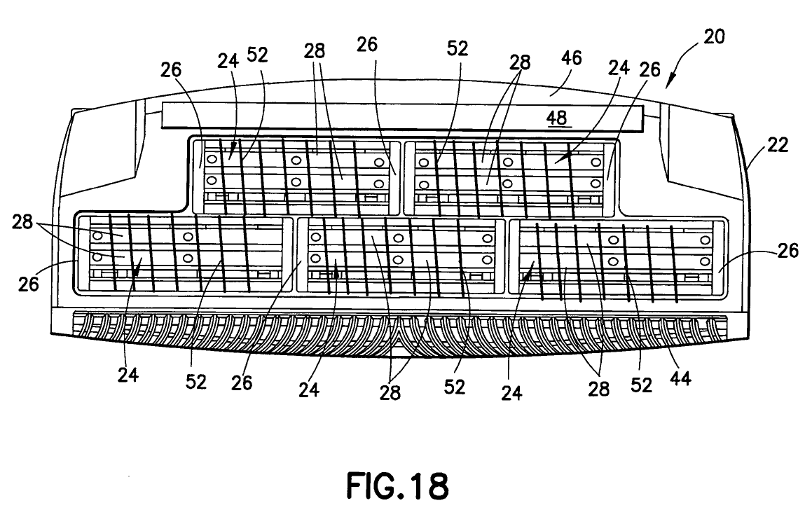

As shown in FIG. 18, the cartridge segments 24 include guard elements 52 which in the illustrated embodiment comprise wire, wrapped around the razor blades 31 to prevent excessive extrusion of a user's skin between the blades during a shaving operation. While wire wrapped razor blades have been shown and described, the present invention is not limited in this regard as other guard elements, such as, protuberances between the blades, can be substituted.

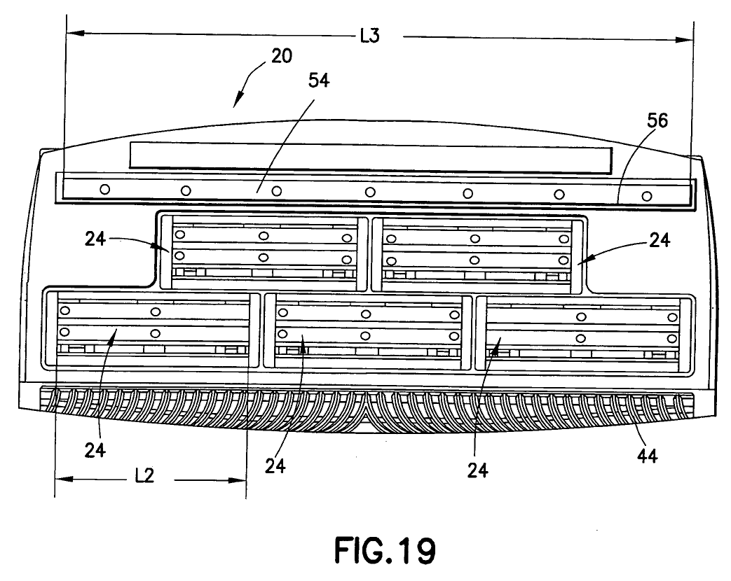

Turning to FIG. 19, the razor cartridge 20 includes a plurality of discrete cartridge segments 24 positioned in adjacent rows. An elongated razor blade 54 is positioned between a cap portion of the razor cartridge 20 and the plurality of cartridge segments 24. As shown in FIG. 19, the razor blade 54 includes an elongated cutting edge 56 of a length L3 that is of a relatively longer dimension than the length L2 of the cutting edges 33 of the razor blades 31 of each of the discrete razor cartridge segments 24. While a single elongated razor blade 54 has been shown in the illustrated embodiment, the present invention is not limited in this regard as more than one elongated razor blade can be employed without departing from the broader aspects of the present invention. Moreover, while the elongated razor blade 52 has been shown positioned adjacent to the cap portion of the razor cartridge, the present invention is not limited in this regard as the elongated razor blade can be positioned in other locations on the cartridge. For example, the elongated razor blade 54 can also be positioned adjacent to the guard portion 44 of the razor cartridge 20 or between adjacent rows of cartridge segments 24.

While preferred embodiments have been shown and described, various modifications and substitutions may be made without departing from the scope of the present invention. Accordingly, it is to be understood that the present invention has been described by way of example, and not by limitation.

What is claimed is:

1. A razor cartridge comprising:
a frame; and
at least two discrete cartridge segments positioned in said frame for independent movement relative thereto, each of said cartridge segments including at least one razor blade having an at least partially exposed cutting edge.

2. A razor cartridge as defined by claim 1, including a plurality of discrete cartridge segments each positioned in said frame for individual movement relative thereto.

3. A razor cartridge as defined by claim 1 wherein each of said cartridge segments is resiliently supported in said frame.

4. A razor cartridge as defined by claim 3 further comprising biasing means positioned in said frame and in communication with each of said cartridge segments for normally urging each of said cartridge segments in a direction towards a surface to be shaved in response to forces exerted against said cartridge segments during a shaving operation.

5. A razor cartridge as defined by claim 4 wherein said biasing means includes a plurality of springs, each coupled to said frame and in engagement with one of said cartridge segments.

6. A razor cartridge as defined by claim 1, wherein each of said cartridge segments includes a housing and, at least one razor blade positioned in said housing said at least one razor blade defining an at least partially exposed cutting edge.

7. A razor cartridge as defined by claim 6 wherein each of said cartridge segments includes two razor blades, the cutting edges of which are approximately parallel to, and spaced apart from one another.

8. A razor cartridge as defined by claim 2 wherein said plurality of cartridge sections are positioned in said frame in at least two substantially parallel, adjacent, rows.

9. A razor cartridge as defined by claim 8 wherein said cartridge sections in one row are offset relative to adjacent cartridge sections in a proximate row.

10. A razor cartridge as defined by claim 8 wherein a number of cartridge segments in one row is different from a number of cartridge segments in another row.

11. A razor cartridge as defined by claim 4 wherein said biasing means includes:
cantilevered spring members, each having one end resiliently coupled to said frame and a generally opposite cantilevered end in engagement with one of said cartridge sections;
wherein said cantilevered end urging said cartridge section in a direction towards a surface to be shaved in response to forces exerted against said cartridge section during a shaving operation.

12. A razor cartridge as defined by claim 11 wherein said cantilevered spring members are integrally formed with said frame.

13. A razor cartridge as defined by claim 12 wherein said frame and said cantilevered spring members are molded together, from a polymeric material, as a single unitary component.

14. A razor cartridge as defined by claim 11 wherein:
each of said cartridge members is resiliently supported by a pair of said cantilevered spring members; and wherein
one of said pair of cantilevered spring members engages said cartridge sections at one end thereof, and the other of said pair of cantilevered spring members engages said cartridge section at a generally opposite end thereof.

15. A razor cartridge as defined by claim 11 wherein said frame includes abutment surfaces each engageable with at least one of said cartridge sections to retain said cartridge section on said frame and to prevent each of said cartridge segments from extending past the neutral position.

16. A razor cartridge as defined by claim 15 wherein:
said frame defines resilient retaining members for coupling said cartridge segments to said frame, each of said retaining members including a stand-off portion;
said abutment surfaces forming part of said retaining members such that during assembly of said razor cartridge said cartridge segments are coupled to said frame by positioning said cartridge segments over said retaining members and exerting sufficient force against said cartridge segments to cause said stand off portions to flex and allow said cartridge segments to be slid past said abutment surfaces; and wherein
when said cartridge segments are coupled to said frame said abutment surfaces limit a movement of said cartridge segments relative to said frame.

17. A razor cartridge as defined by claim 2 wherein at least a portion of said cartridge segments are positioned in said frame in an arcuate configuration.

18. A razor cartridge as defined by claim 2 wherein at least a portion of said cartridge segments are positioned in said frame in a circular pattern.

19. A razor cartridge as defined by claim 1 wherein said frame includes a guard bar coupled thereto.

20. A razor cartridge as defined by claim 1 further comprising at least one comfort strip coupled to said frame.

21. A razor cartridge as defined by claim 1 wherein a first of said at least two distinct cartridge segments are positioned in said frame so that the cutting edges of the razor blades located in said first cartridge segment generally face away from the cutting edges of the razor blades positioned in a second of said at least two distinct cartridge segments, thereby allowing said razor cartridge to cut hair when moved over a surface to be shaved in either of two generally opposite directions.

22. A razor cartridge as defined by claim 1 wherein a first of said at least two distinct cartridge segments are positioned in said frame so that the cutting edges of the razor blades located in said first cartridge segment generally face toward the cutting edges of the razor blades positioned in a second of said at least two distinct cartridge segments, thereby allowing said razor cartridge to cut hair when moved over a surface to be shaved in either of two generally opposite directions.

23. A razor cartridge as defined by claim 1 wherein said at least one razor blade is wire wrapped to minimize extrusion of a surface to be shaved between successive razor blades or between one razor blade and a surface adjacent the razor blade.

24. A razor cartridge as defined by claim 1 wherein each of said razor blades is coupled to a stiffener, each of said stiffeners defining at least one aperture extending therethrough to facilitate washing of shaving debris from said razor cartridge.

25. A razor cartridge as defined by claim 1 further comprising at least one elongated razor blade coupled to said razor cartridge and extending longitudinally thereof, said elongated razor blade having an exposed cutting edge extending over substantially all of an elongated length of said frame of said razor cartridge.

26. A shaving implement comprising:
a handle;
a razor cartridge coupled to said handle, said razor cartridge including;
a frame; and
at least two discrete cartridge segments positioned in said frame for individual movement relative thereto, each cartridge segment including at least one razor blade having an at least partially exposed cutting edge.

27. A shaving implement as defined by claim 26 wherein said razor cartridge is disposable and is releasably coupled to said handle.

28. A shaving implement as defined by claim 26 wherein said razor cartridge is coupled to said handle for angular movement relative thereto.

29. A shaving implement as defined by claim 26 wherein said razor cartridge includes a plurality of discrete cartridge sections coupled to said frame, each for independent movement relative thereto.

30. A razor cartridge comprising:
a frame;
at least one discrete cartridge segment positioned in said frame for individual movement relative thereto, said cartridge segment including at least one razor blade having an at least partially exposed cutting edge; and
biasing means positioned in said frame and in communication with said at least one cartridge segment for normally urging said cartridge segment in a direction towards a surface to be shaved in response to forces exerted against said cartridge segment during a shaving operation.

31. A razor cartridge as defined by claim 30 wherein said biasing means includes at least one cantilevered spring member having one end resiliently coupled to said frame and a generally opposite cantilevered end in engagement with said cartridge section for normally urging said cartridge section in a direction towards said surface to be shaved in response to forces exerted against said cartridge section during a shaving operation.

32. A razor cartridge as defined by claim 30, further comprising:
at second discrete cartridge segment positioned in said frame for movement relative thereto, said cartridge segments including at least one razor blade having an at least partially exposed cutting edge; and wherein
said second discrete cartridge segment is positioned in said frame so that the cutting edges of its at least one razor blade generally faces away from the cutting edges of said razor blade of said at least one cartridge segment, thereby allowing said razor cartridge to cut hair when moved over a surface to be shaved in either of two generally opposite directions.

33. A razor cartridge as defined by claim 30, further comprising:
at second discrete cartridge segment positioned in said frame for movement relative thereto, said cartridge segments including at least one razor blade having an at least partially exposed cutting edge; and wherein
said second discrete cartridge segment is positioned in said frame so that the cutting edges of its at least one razor blade generally faces toward the cutting edges of said razor blade of said at least one cartridge segment, thereby allowing said razor cartridge to cut hair when moved over a surface to be shaved in either of two generally opposite directions.
